(19) United States
(12) Patent Application Publication
(10) Pub. No.: US 2009/0174958 A1
(43) Pub. Date: Jul. 9, 2009

(54) System of multiple view safety mirrors for motor vehicles

(76) Inventor: Andre Roberson, Houston, TX (US)

Correspondence Address: DARCELL WALKER, 8107 CARVEL LANE, HOUSTON, TX, 77036, US

(21) Appl. No.: 12/006,875

(22) Filed: Jan. 7, 2008

(51) Int. Cl. G02B 7/182

(52) U.S. Cl. 359/854; 359/860

(57) ABSTRACT

A system of mirrors provides multiple views of the various sides of a vehicle to the driver. In this system, one mirror is a conventional mirror that shows the conventional rear and side views of the vehicle. The second mirror can be adjacent the conventional mirror but angled away from the conventional mirror such that this second mirror does not reflect in the same direction as the conventional mirror. The third (outer) mirror is positioned such that it faces a direction somewhat opposite from the second mirror. The mirrors are contained in a housing that has a clear or transparent side opposite the side of the housing containing. The third mirror is position such that mirror reflects an image of the contents that are seen through transparent side of the mirror housing. This image shown in the third mirror is reflected by the second mirror such that the driver can look through the second mirror and see images that are in the front of the vehicle.

### FIELD OF THE INVENTION

This invention relates to an automotive side view and rear view mirror system, and particularly to a set of rear view mirrors in which each mirror provides a view of various sides of an automobile thereby minimizing blind spots behind the vehicle on which the mirror is installed.

### BACKGROUND OF THE INVENTION

Currently, side view mirrors on vehicles provide a limiting view of the road. Drivers are forced into choosing a blind spot situation in order to determine what is on the side of and behind their vehicle. When drivers look into normal rearview mirrors, objects in the front of the vehicle are in a blind spot. This occurs when the driver uses the side-view mirror for merging to the left or right. The blind spot that is created when the side-view mirrors are used is the reason for rear end collisions and pedestrian accidents. The driver must focus on the mirror then turn the head quickly in order to see if everything is clear in front of the vehicle. Often times drivers will watch as a vehicle in front of them begins to pull away and assume the vehicle has continued moving on and then they will look in their side-view mirror as they begin to merge. The only problem is that vehicles in front often are only making an adjustment or have not committed to moving on. At the time that the front vehicle's brakes are reapplied, the eye's of the driver in the second vehicle is concentrated on the side-view mirror. The result is a rear end accident as the lead car stops and the second car accelerates in an attempt to merge with traffic. This same scenario is responsible for vehicle pedestrian accidents. The driver looks to the side view mirror as a lead car moves on, and fails to see that a pedestrian has taken the opportunity to attempt to cross in front of the driver's vehicle.

The main function of the conventional side view mirror has not changed much, as vehicles have evolved. During that era, the maximum vehicle speed was only 45 mph. Since then, all components of vehicles have been upgraded to help the driver deal with the greatly increased acceleration, speed and power of the modern vehicle. Manufacturers of tires, brakes, lights, steering wheels, etc. have all realized that the Model T style safety offerings would be a hazardous addition to modern vehicles. The side view mirror, though bombarded with additional gadgetry such as signal lights and remote adjustment, has not kept up with a driver's need for information.

As cities grow, drivers must maneuver on congested freeways and pedestrian packed streets. Accidents happen when drivers are forced to loose fresh perspective of the area in front of their vehicle. Conventional side view mirrors still require drivers to completely take their eyes off of the road in front of them to assess what is happening to the rear and side of the vehicle. Referring to FIG. 1, shown are the head movements of a driver trying to visually monitor views of all sides of the vehicle while driving. View 102 is through the driver's side rear view mirror. View 104 is when the driver is looking straight ahead or through the center rear view mirror. View 106 is when the driver is looking through the passenger side rear view mirror. In an attempt to maintain a fresh view of the areas of road in front, to the side and in back of the vehicle, drivers have to turn their heads “back and forth” quickly and repeatedly. This practice is dangerous, as each time that the user's cycle through these motions, they must refocus to gain perspective and totally loose contact with what is happening in the other view. This action is often done 5 to 10 times at each intersection before a clearing appears to exist, giving the driver a less than fresh view of the areas of roadway that concern him/her. Ergonomically speaking, repetitive motion such as this has been minimized in the office environment and should be reduced in driving as well.

Since modern vehicles accelerate faster, drivers spend more time, and look more intently into the side view mirror to assess potential hazards as they can materialize quickly. Driving conditions have changed from single lane roads at 20 mph to 8 lane freeways at 70 mph, from open prairies to dense cities, all of which means much more merging, which equals much more time looking in the side-view mirror. This causes accidents. While it is important to know of these hazards to the rear and side of the vehicle, it is equally, if not more important to know what is transpiring in front of one's vehicle. If a lead vehicle, brakes while a driver is looking in a conventional side view mirror a rear end accident occurs, as the trailing vehicle's driver is forced into a (non forward viewing) tunnel vision scenario in order to gain a side and rear perspective of the road. Exchanging 1 blind spot for a more dangerous blind spot.

FIG. 2 illustrates a common accident scenario. In this commonly encountered situation, Car #2 wants to merge left in order to pass Car #1. In order to do this Car #3 must be cleared/sufficiently passed. The driver of Car #2 uses side-view mirrors to insure that the maneuver is safe. While Car #2 driver is looking in the side view mirror, Car #1 hits it's brakes. Car #2 doesn't see the change of events in front of the vehicle. The result is a rear end accident.

In the accident scenario illustrated in FIG. 3, Cars #2 and #3 need to merge with ongoing traffic. Car #2 moves forward to better gauge the flow of traffic on the road that he needs to merge onto. Car #3 sees Car #2 get of the brakes and begins to move forward thinking that Car #2 has moved on and that the way is now clear. Due to the fact that the driver of Car #3 instinctively begins to look in the side view mirror as he moves forward. He does not see that Car #2 was only adjusting his vehicle's position and re-applied his brakes. The result is a rear in accident as Car #3 accelerates to merge with the traffic.

Referring to accident scenario in FIG. 4, when merging with traffic, the driver of Car #2 looks in his side view mirror to clear the way to his left. When pedestrians enter into lanes of traffic from the right. They assume that Car #2 sees them since the car is standing still. But the driver of Car #2 has his attention focused on the traffic to his left. When an opening appears for Car #2 in traffic, the driver accelerates and strikes the pedestrian. Not knowing that the pedestrian has entered into the roadway, taking that opportunity to cross the street.

In the last scenario shown in FIG. 5, Car #4 looks to the left to view oncoming traffic Car #2 and #3 to determine the best time to pull out. When looking at Car #3, Car #2 is not seen and pedestrians can enter the drive path. The drive path is constantly viewed with slight eye.

Other rear view mirror systems and devices have been developed to address the problems associated with rear view mirrors on motor vehicles. To minimize the undesired blind spots it has been proposed to incorporate curved convex reflective surfaces in rear view mirrors. Such convex reflective surfaces minimize blind spots by increasing the mirror's viewing angle. Convex mirror surfaces that are convex in two orthogonal planes are sometimes termed “fisheye” mirror surfaces.

One problem with fisheye mirrors is distortion of the image generated by the mirror surface. Also, the image can be deceptively smaller than images generated by flat-surfaced mirror surfaces. U.S. Pat. No. 5,517,367, issued to R. H. Kim on May 14, 1996, shows a rear view mirror having convex “fisheye” mirror surfaces.

There remains a need for a solution that is a side, rear, and front view mirror assembly to provide drivers with multiple views of the sides and front of the vehicle while the driver is looking in only one direction. This solution should require a fraction of the movement as conventional approaches to using rear view and side view mirrors.

### SUMMARY OF THE INVENTION

This invention provides a safer, and more efficient method and system for maneuvering of vehicles when driving by allowing consistent monitoring of the complete roadway while generally looking in one direction. A system of mirrors are positioned on the side of the vehicle such that each mirror shows the conditions in one direction of the vehicle. One embodiment of the system of the present invention provides a set of mirrors. One mirror is a conventional mirror that shows the convention rear view of the vehicle. The second mirror can be adjacent the conventional mirror but angled away from the conventional mirror such that this second mirror does not reflect in the same direction as the conventional mirror. The third (outer) mirror is positioned such that it faces a direction somewhat opposite from the second mirror. The mirrors are contained in a housing that has a clear or transparent side opposite the side of the housing containing. The third mirror is position such this mirror reflects an image of the contents that are seen through transparent side of the mirror housing (see FIG. 8). This image shown in the third mirror is reflected by the second mirror such that the driver can look through the second mirror and see images that are in the from of the vehicle.

The present invention substantially reduces blind spots, while shortening reaction times to events happening in front of the vehicle thus reducing the number of accidents. The present invention allows the user to gain and maintain views behind, to the side and in front of the vehicle, eliminating the tunnel vision required to use conventional mirrors. If a driver is looking in the mirror of the present invention and a lead vehicle brakes, the lead vehicle's tail or rear lights are reflected and seen by the driver instantly. This feature acts as an early warning system, allowing the trailing driver to brake also, with quicker reaction times for accident avoidance. (See FIG. 3)

If the vehicle is stationary and the driver is looking in the present invention and a pedestrian walks into the drive path, the driver can see the pedestrian. The pedestrian's movement alerts the driver to an event change.

### DESCRIPTION OF THE DRAWINGS

FIG. 1 is an illustration of the different positions in which a driver turns their head to look through rear view and side view mirrors and through the windshield.

FIG. 2 is an illustration of a scenario when a car wants to merge left in order to pass a car.

FIG. 3 is an illustration of a scenario when two cars need to merge with ongoing traffic.

FIG. 4 is an illustration of a scenario when a merging with traffic, a driver looks in his side view mirror to clear the way to the driver's left.

FIG. 5 is an illustration of a scenario when a driver looks to the left to view oncoming traffic to determine the best time to pull out.

FIG. 6 is a diagram illustrating the concept of the mirror system of the present invention.

FIG. 7 is a diagram illustrating an embodiment of the present invention, which allows the driver to view around a main mirror and to the front of the vehicle.

FIG. 8 is a diagram of the mirror system of the present invention.

FIG. 9 is an exploded view of the mirror system of the present invention.

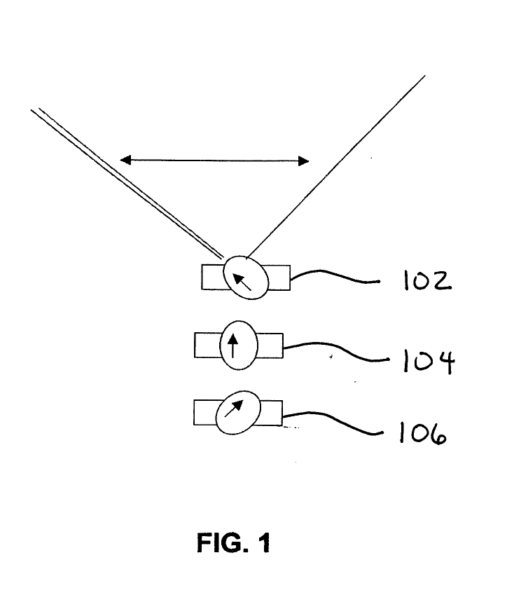

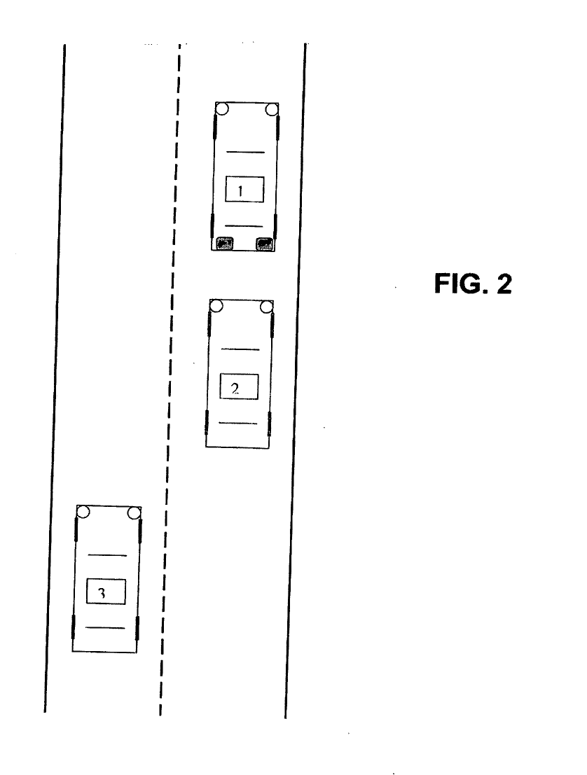

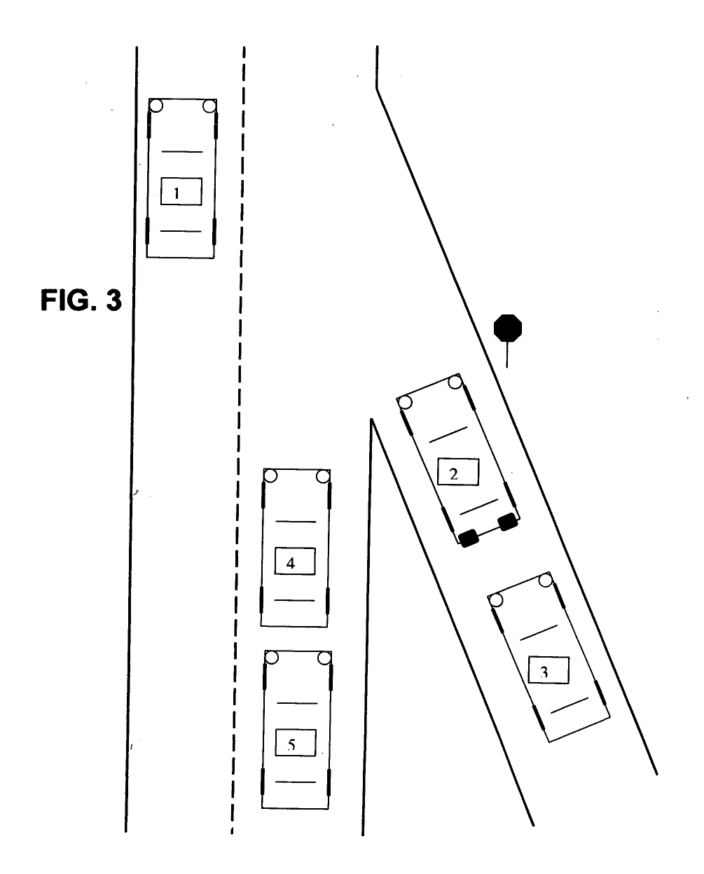

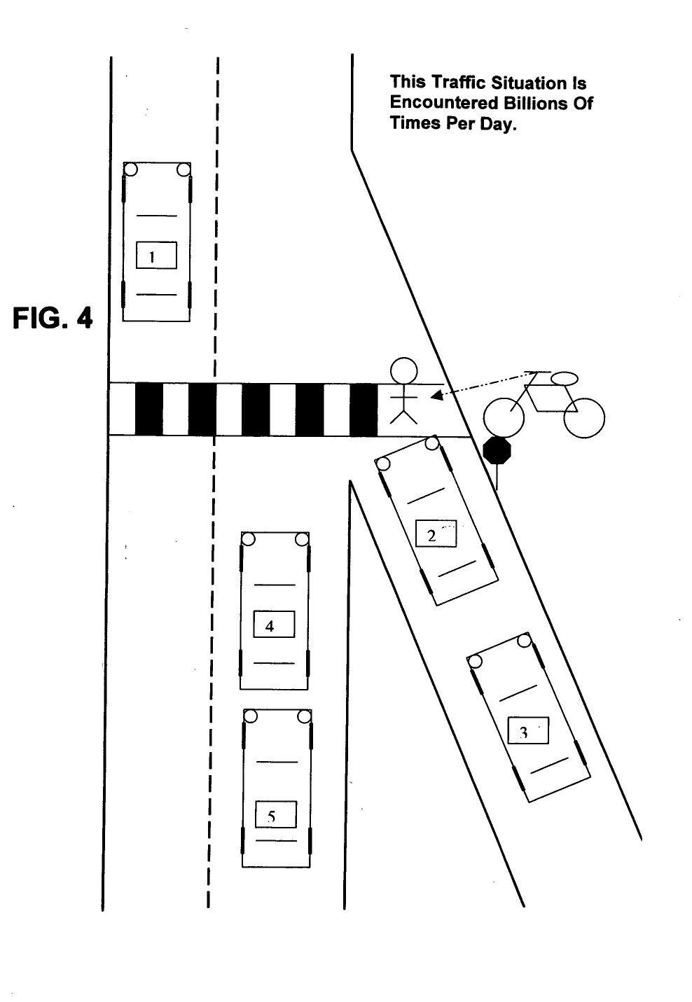

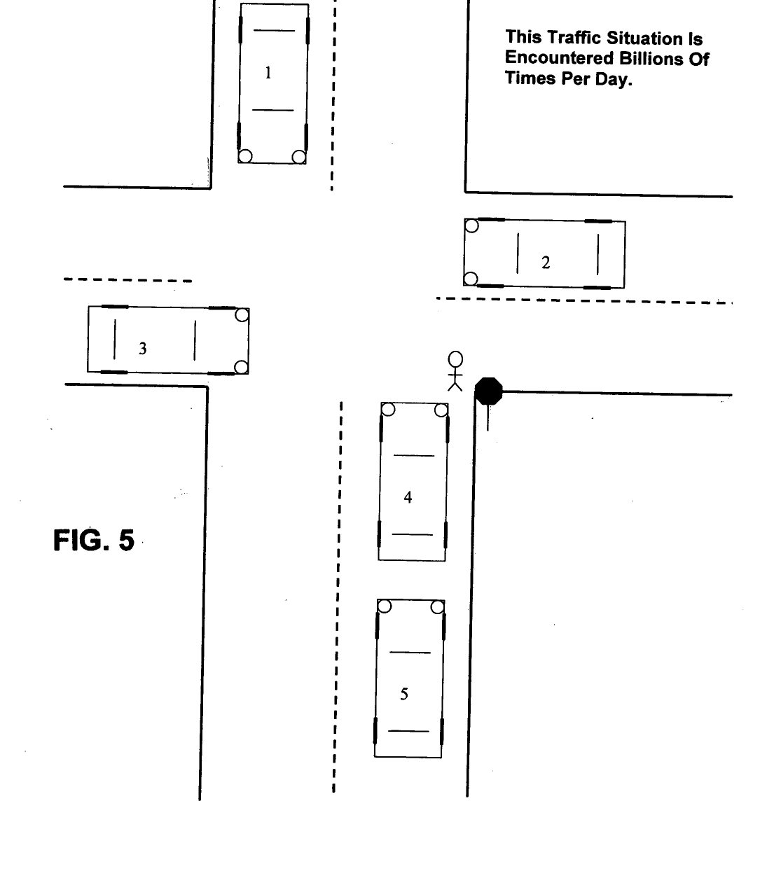

### DETAILED DESCRIPTION OF THE INVENTION

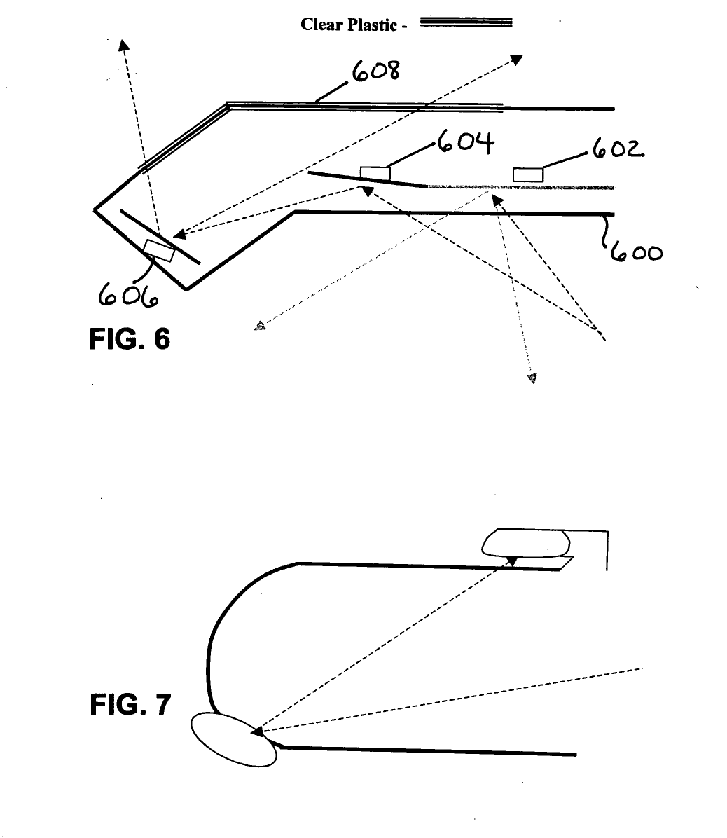

The present invention provides a mirror system for a motor vehicle that enables the driver to simultaneously view multiple sides of the vehicle from one mirror system. As shown FIG. 6, a system of mirrors that provide a rear view and a front view of the motor vehicle. A mirror housing 600 contains three mirrors. Mirror 602 is a conventional mirror that is currently used for showing the rear view of a vehicle. This mirror 602 directly faces the rear of the vehicle. As the driver looks through this mirror, the driver sees a conventional rear view of the vehicle.

Mirror 604 is positioned between mirror 602 and mirror 606. Mirror 604 is positioned such that it indirectly faces mirror 604. Mirror 604 will reflect a reflection of the image viewed in mirror 604. Mirror 606 is positioned such that it reflects images through a clear and transparent opening 608 in the mirror system housing 600. This transparent opening 608 is on the side of the housing that faces the front of the vehicle. Through this transparent opening, mirror 606 will reflect the front view of the car. Mirror 604 will reflect the view of the front of the vehicle provided by mirror 606. From the view of mirror 604, the driver can view the front of the view without turning his/her head to actually look forward. The transparent opening can have a clear cover to shield wind and for aerodynamic purposes. This cover can also have a tint.

FIG. 7 shows a mirror system of the present invention, which allows the driver to see around the main mirror and to the front of the vehicle. This embodiment is also a system of the present invention that can be attached to a conventional vehicle in order to modify that vehicle. The preferred embodiment of the system of the present invention would probably be installed on newly manufactured vehicles.

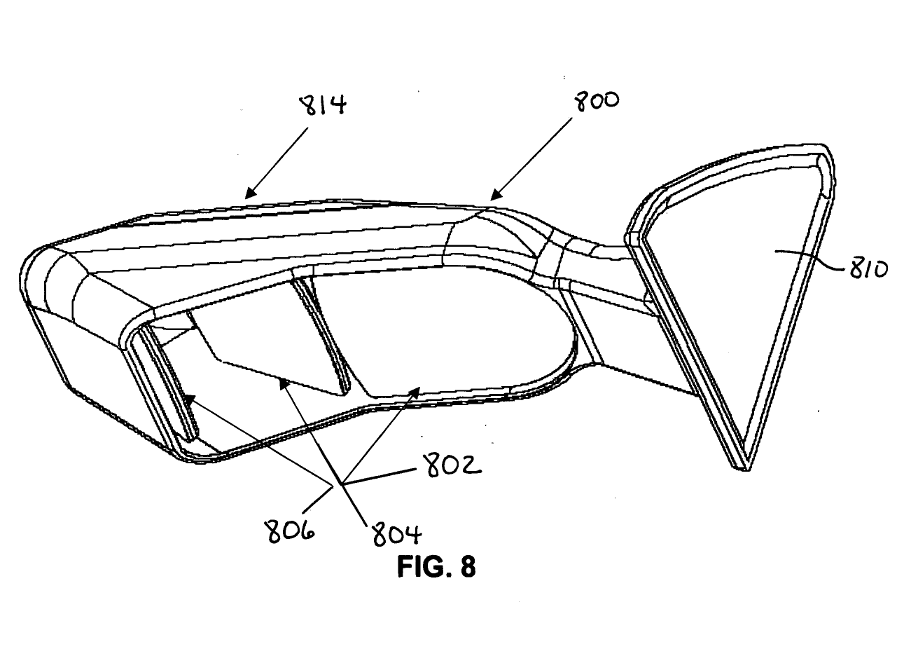

FIG. 8 shows a view of the main embodiment of the present invention. As shown, the mirror has a housing 800 that is similar to the housing of a conventional rear view mirror and side view mirror. The housing attaches to the vehicle via the attaching element 810. This attaching element is the end of the neck portion 812 of the housing 800. Mirror 802 can be a conventional rear view mirror. Mirrors 804 and 806 work together to show a view of the front of the vehicle. The mirrors can be convex mirrors with pivot points that allow for adjusting of the mirrors. The adjustments can produce better reflection angles for viewing the various sides of the vehicle. The adjustments to the mirrors can also be automated. The adjustable pivoting mirrors (804) can also be angled in such a way to allow the user to see the reflection from another mirror (806) that is angled toward the front of the vehicle. In the main housing 800 is a clear and transparent section 814. From this clear section, mirror 806 can reflect a view of the front of the vehicle.

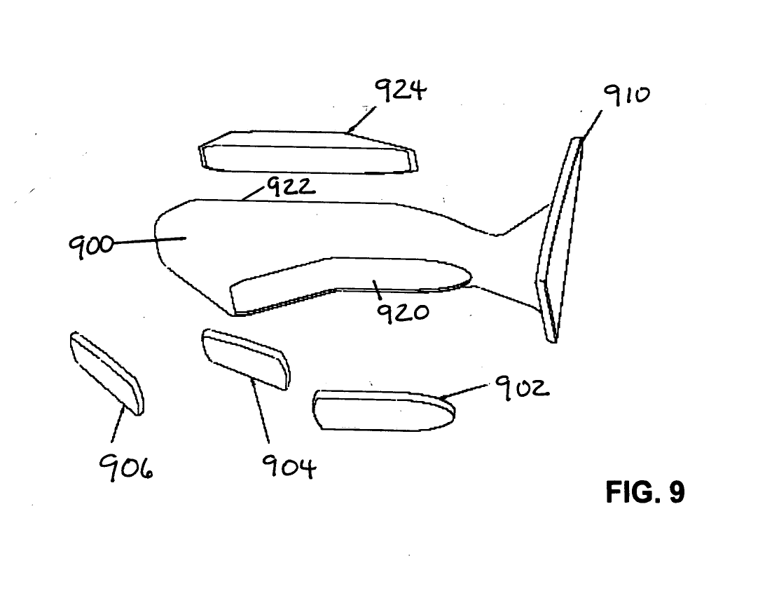

FIG. 9 is an exploded view of the mirror system of the present invention. Shown is a housing assembly 900, having a front opening 920 and a rear opening 922. Over the rear opening 922 is a clear or transparent cover 924 that enables mirror 906 to reflect a view of the front of the vehicle. Mirrors 902, 904 and 906 are positioned in the housing such that they can pivot to provide the ability to adjust the mirror angles for better or desirable viewing.

The present invention has an adjustable, pivoting convex mirror that allows the user to see what is on the side and rear of the vehicle. (mirror adjustments can be automated). The present invention also has an adjustable, pivoting mirror angled in such a way to allow the user to see the reflection from another mirror that is angled toward the front of the vehicle. The present invention has adjustable, pivoting mirrors angled in such a way to see forward. These mirrored surface allow the user to maintain a frontal view from the vehicle simultaneously as well as to the rear and to the sides of the vehicle. The present invention has an aerodynamic design that allows for reduced wind drag. The present invention has a antifogging clear/see-through portion made into the mirror that allows the user to maintain a frontal view of the driving experience.

A second embodiment of this invention is to have the adjustable mirrors (used for maintaining frontal view) mounted on to existing mirrors. These mirrors adjust to look into one another and angled to provide a view of the area in front and to the sides of the vehicle.

The present invention reduces the frontal blind spot by providing the driver with a method to more readily see the braking of the car in front and a fresher view of the scene and events happening in front of the driver's vehicle. The present invention can be used on all types of vehicles, which include but not limited to cars, trucks, motorcycles, boats etc. The present invention provides for safer maneuvering of vehicles by eliminating side, rear and frontal blind spots. No more need for jerking the head to the side and to the front over and over again in order to maintain a fresh view of the vehicles situation and events around the vehicle. The present invention provides is a viable product for all vehicle markets.

The multiple view mirror system of this invention provides significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention.

I claim:

1. A multiple view mirror system for use in motor vehicles which enables a driver to simultaneously view multiple images of the sides of a motor vehicle comprising:
a mirror housing attachable to a motor vehicle in a position such that the driver can view mirrors contained in the housing from the driver's seat, the housing having a hollow interior, the housing also having a front side and a rear side, each of the front and rear sides have openings;
a transparent element fitting covering the rear opening of the housing to provide for the passing light from the front of the vehicle and through the housing such that a view of the front of the vehicle can be reflected and viewed through a mirror in the housing;
a first mirror positioned in the housing for reflecting views of the rear of the motor vehicle;
a second mirror positioned in the housing and adjacent the said first mirror position; and
a third mirror positioned in the housing and adjacent said second mirror for reflecting views from the front of the motor vehicle.

2. The system as described in claim 1 wherein said first, second or third mirrors are pivotally mounted in the housing.

3. The system as described in claim 1 wherein said second and third mirrors are positioned such that the third mirror reflects a view from the front of the vehicle via said transparent cover on the housing.

4. The system as described in claim 3 wherein an image reflected in said third mirror is reflected into said second mirror.

5. The system as described in claim 4 wherein the image reflected in said second mirror can be viewed by a driver of the vehicle.

6. The system as described in claim 1 wherein said transparent element fitting comprises a tinted material.
